(19) United States
(12) Patent Application Publication
(10) Pub. No.: US 2024/0282977 A1
(43) Pub. Date: Aug. 22, 2024

(54) FUEL CELL WITH STRUCTURAL ELEMENT INTEGRALLY BONDED TO A GAS DIFFUSION ELEMENT

(71) Applicant: MTU Aero Engines AG, München (DE)

(72) Inventors: Ann-Kathrin Henss, München (DE); Barnaby Law, Starnberg (DE)

(73) Assignee: MTU Aero Engines AG, München (DE)

(21) Appl. No.: 18/570,468

(22) PCT Filed: Jun. 3, 2022
(86) PCT No.: PCT/DE2022/100416

§ 371 Date: Dec. 14, 2023

(30) Foreign Application Priority Data
Jun. 18, 2021 (DE) 10 2021 115 772.2

(51) Int. Cl. H01M 4/86; B64D 27/355; H01M 8/1004

(52) U.S. Cl. CPC H01M 4/8631; H01M 8/1004; B64D 27/355; H01M 2004/8694; H01M 2250/20

(57) ABSTRACT

A description is given of a fuel cell comprising an electrode-membrane unit comprising a cathode and an anode, a cathodal gas diffusion element, an anodal gas diffusion element, the electrode-membrane unit being accommodated between the gas diffusion elements; a cathodal bipolar plate, and an anodal bipolar plate. Provision is made here for the cathodal gas diffusion element or/and the anodal gas diffusion element to have at least one structural element facing the respective bipolar plate and integrally bonded to the relevant gas diffusion element.

### BACKGROUND OF THE INVENTION

The present invention relates to a fuel cell having an electrode-membrane unit with a cathode and an anode, a gas diffusion element at the cathode side, a gas diffusion element at the anode side, wherein the electrode-membrane unit is accommodated between the gas diffusion elements, a cathodal bipolar plate, and an anodal bipolar plate. Moreover, the invention relates to a fuel cell stack having multiple fuel cells as well as an aviation propulsion drive having at least one such fuel cell.

For the use of fuel cells, it is known how to arrange an additional component between a bipolar plate and the electrode-membrane unit, this component having a favorable influence on the water budget of the fuel cell. For this, refer to DE 198 53 911 A1, EP 1 639 668 B1 and U.S. Pat. No. 9,461,311 B2, for example.

Such additional components, which can also be called insert parts, are a disadvantage particularly in the assembly process of the fuel cell, because a further component needs to be installed. Depending on the material used for the additional component, this also leads to greater weight for the individual fuel cell, which has an overall negative effect on the total weight of a fuel cell stack having multiple fuel cells.

### SUMMARY OF THE INVENTION

The object that is viewed as the basis of the invention is proposing a fuel cell in which the above drawbacks can be avoided and an optimized water budget is achieved.

This object is achieved in that a fuel cell is proposed having the features of the present invention. Preferred and optional embodiments are contained in the dependent claims.

Thus, there is proposed a fuel cell having an electrode-membrane unit with a
cathode and an anode,
a cathodal gas diffusion element,
an anodal gas diffusion element,
wherein the electrode-membrane unit is accommodated between the gas
diffusion elements;
a cathodal bipolar plate, and
an anodal bipolar plate.

It is provided that the cathodal gas diffusion element or/and the anodal gas diffusion element comprises at least one structural element facing toward the respective bipolar plate and being integrally bonded to the respective gas diffusion element.

The structural element and the gas diffusion element are thus connected to each other so as to form a single component, simplifying the assembling of the fuel cell. The integral bonding of the structural element can occur in particular during the production of the gas diffusion element, so that the gas diffusion element comprises the structural element after its production. The integrally bonded structural element also has the advantage, in particular, that it can play the part of stiffening the gas diffusion element, which simplifies the handling of the gas diffusion element.

The principal functions of the gas diffusion layer or gas diffusion element are the uniform diffusion-driven gas transport to the electrode, the conduction of electrons and the removal of water produced at the cathode side. In addition, a good thermal conductivity as well as mechanical and chemical stability are important for the function of the fuel cell. These diversified requirements make metals or carbons the preferred materials. According to one embodiment, the gas diffusion element is fabricated from a porous metal or carbon material, or one riddled with holes or channels, and being relatively limp or flexible (as compared to the structural element). In one preferred embodiment, gas diffusion elements are made based on carbon fiber paper, fabric, or nonwovens.

In the fuel cell, the structural element can be an at least partial coating of the respective gas diffusion element. The structural element can be configured for at least a portion as a rib or strip. Uncoated interstices or meshes can be formed between the ribs or strips. In addition, the structural element can be made from a material not permeable to gas and/or water. In this way, it is possible through the integrally bonded structural element or multiple structural elements or a partial coating to influence the permeability of the gas diffusion element and thus the water budget. The material used for the structural element can be a suitable plastic, for example.

In the fuel cell, the permeability of the respective gas diffusion element can be established by multiple structural elements and their relative positioning to each other in dependence on a main flow direction of gas in gas flow ducts of the respective bipolar plate. The permeability may increase along the main flow direction, especially in linear manner. In this way, drainage can be facilitated at those places of the gas diffusion elements where large amounts of liquid (water) are anticipated, so that the water budget of the fuel cell can be optimized.

In the case of the fuel cell, the at least one structural element can be sprayed onto the respective gas diffusion element. In other words, the structural element or multiple structural elements can be easily sprayed onto a respective gas diffusion element by means of an appropriate spraying device, in order to achieve a desired permeability for the gas diffusion element.

A fuel cell stack can be outfitted with multiple fuel cells as described above.

An electrical aviation propulsion drive, especially one having a propeller or/and an aviation gas turbine, can be connected to at least one such fuel cell stack in order to supply the aviation propulsion drive with electrical energy. But such a fuel cell stack can be used not only in aircraft or in aviation propulsion drives, but also in other areas of electromobility and power supply.

### BRIEF DESCRIPTION OF THE DRAWING FIGURES

In the following, the invention shall be described as an example, but is not limited to this example, making reference to the enclosed figures.

FIG. 1 shows in simplified form and schematically a fuel cell having a structural element at the cathode side.

FIG. 2 shows in the figure parts A) to C) various configurations of the structural element on a respective gas diffusion element.

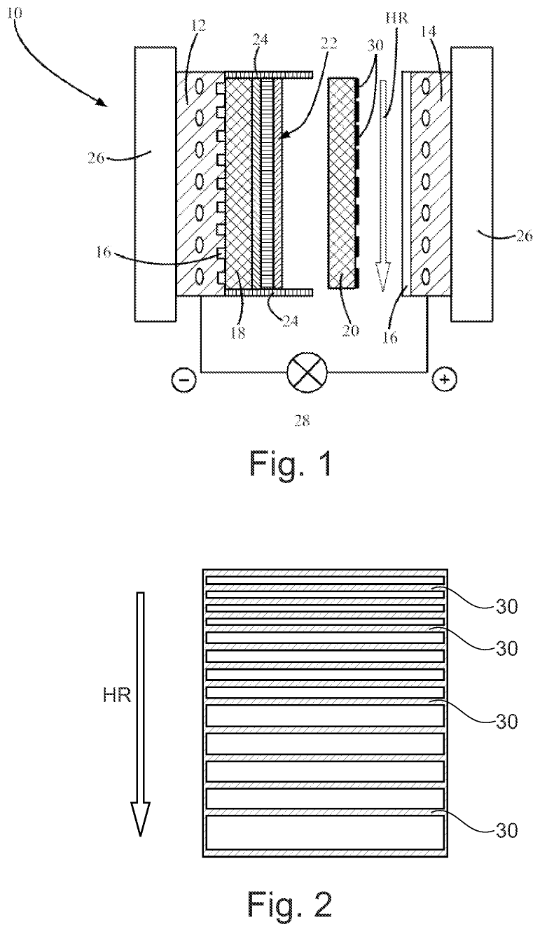

FIG. 1 shows in simplified form and schematically a fuel cell 10, certain components being represented spaced apart from each other for better illustration.

### DESCRIPTION OF THE INVENTION

The fuel cell 10 here is represented, for example, as a so-called polymer electrolyte membrane fuel cell (PEM fuel cell). The fuel cell 10 comprises a bipolar plate 12 at the anode side and a bipolar plate 14 at the cathode side. Gas ducts 16 carrying process gas, such as air or hydrogen, are indicated in the bipolar plates 12, 14. Further, the fuel cell comprises a gas diffusion element 18 at the anode side and a gas diffusion element 20 at the cathode side. Between the two gas diffusion elements 18, 20 there is accommodated or arranged an electrode-membrane unit 22. For sake of completeness, sealing elements 24 are also indicated. Moreover, end plates 26 are also shown, which hold together the fuel cell components. In an assembled state of the fuel cell 10, the end plates 26 are joined together or tensioned by a fastening device, not shown here.

By means of the fuel cell 10, an electrical consumer 28 can be supplied electrically with electrical energy in known manner. The electrical consumer 28 here stands for an electrically driven motor, for example, an electrical storage unit (battery), or the like.

The cathodal gas diffusion element 20 comprises on its side facing toward the bipolar plate 14 at the cathode side at least one structural element 30. The at least one structural element 30 or the multiple structural elements 30 is or are integrally bonded to the gas diffusion element 20. In particular, the structural elements 30 can be sprayed or sputtered onto the gas diffusion element 20. The gas diffusion element 20 and the structural element 30 thus form an integral component with the fuel cell 10.

What has been said above in regard to the cathodal gas diffusion element 20 and the structural elements 30 can also be applied to an anodal gas diffusion element 18. In particular, a structural element 30 can also be provided on an anodal gas diffusion element 18, even when this is not explicitly described or shown.

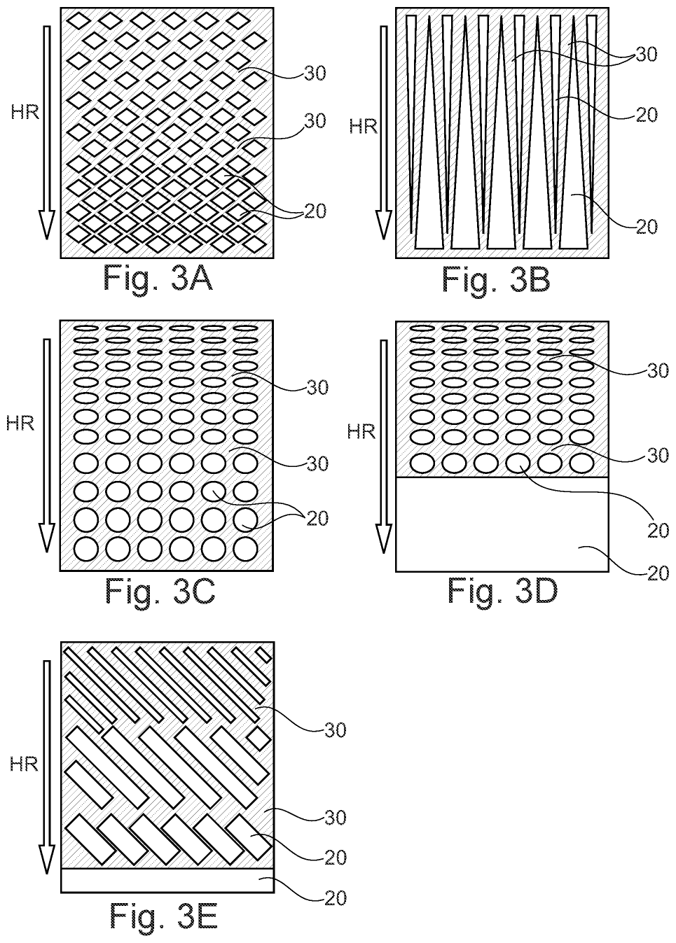

FIG. 2 shows in a simplified and schematic representation a view of the cathodal gas diffusion element 20 with structural elements 30. The gas diffusion element 30 or its side facing toward the bipolar plate 14 are shown here as white, while the structural elements 30 are illustrated as dark.

The structural elements 30 form a partial coating on the gas diffusion element 20. In particular, the structural elements 30 form regions that are impenetrable to gas or water. In the example of FIG. 2, the structural elements 30 are arranged with varying distance from each other. In particular, the distance between the structural elements 30 decreases from top to bottom in the figure. Due to the varying distance of the structural elements 30, their relative positioning with regard to each other is set so that the permeability of the gas diffusion element 30 is set in dependence on a main flow direction HR of gas in the gas flow ducts 16 of the bipolar plate 14.

In the example of FIG. 2, the permeability increases along the main flow direction HR, because the spacings between the structural elements 30 become larger.

The sprayed or sputtered structural elements 30 in the example of FIG. 2 form horizontally running ribs or strips. In this way, the gas diffusion element 20 can also be made more mechanically stable, in particular, it can be stiffened.

FIG. 3 shows in the figure parts A) to E) various examples of how to configure structural elements 30 on a gas diffusion element 18, 20 at the anode side or at the cathode side.

In FIG. 3A it is shown for example that the free or permeable regions formed by the deposited structural elements 30 are configured as polygons of equal size, here being rhombuses. The permeability is achieved in that the distance between the permeable regions (rhombuses) decreases from top to bottom. In other words, the dimensions of the structural elements 30 and the partial coating are adapted appropriately.

In FIG. 3B it is shown for example that the free or permeable regions formed by the deposited structural elements 30 are configured as triangles.

FIG. 3C shows an example in which the free or permeable regions formed by the structural elements 30 are configured as circles or ellipses. The surface of the formed ellipses or circles increases from top to bottom, so that also in this instance the permeability can be suitably influenced.

FIG. 3D shows an example similar to FIG. 3C, although a lower portion of the gas diffusion element 18, 20 has no structural element 30 or no coating.

FIG. 3E shows an example in which the free or permeable regions formed by the structural element 30 are configured as diagonally running rectangles having different surfaces. Also in this example, no coating or no structural element 30 is provided in a lowermost portion of the gas diffusion element 18, 20.

The examples shown in FIGS. 2 and 3 for the configuration of the structural elements 30 (or partial coatings) are merely exemplary, and further geometrical configurations are conceivable. But all the examples have the common feature that the permeability increases due to the geometrical configuration or arrangement of structural elements 30 or a corresponding coating along the main flow direction HR of gas; in particular, it increases almost linearly. The free or permeable regions can also be called uncoated interstices or meshes.

Several of the fuel cells 10 shown in FIG. 1 having at least one gas diffusion element 18, 20 with a structural element 30 or a coating, can be assembled to form a fuel cell stack.

Such a fuel cell stack can be used for the energy supply in an aviation propulsion drive. The fuel cell stack can be connected electrically, directly or indirectly (via a battery storage), to the aviation propulsion drive.

1. A fuel cell having
an electrode-membrane unit with a cathode and an anode,
a cathodal gas diffusion element,
an anodal gas diffusion element,
wherein the electrode-membrane unit is accommodated between the gas diffusion elements;
a cathodal bipolar plate, and
an anodal bipolar plate,
wherein the cathodal gas diffusion element or/and the anodal gas diffusion element comprises at least one structural element facing toward the respective bipolar plate and being integrally bonded to the respective gas diffusion element.

2. The fuel cell according to claim 1, wherein the at least one structural element is an at least partial coating of the respective gas diffusion element.

3. The fuel cell according to claim 1, wherein the structural element is configured for at least a portion as a rib or strip.

4. The fuel cell according to claim 2, wherein the at least one structural element is made from a material not permeable to gas and/or water.

5. The fuel cell according to claim 4, wherein the permeability of the respective gas diffusion element is established by multiple structural elements and their relative positioning to each other as a function of a main flow direction of gas in gas flow ducts of the respective bipolar plate.

6. The fuel cell according to claim 5, wherein the permeability increases along the main flow direction in a linear manner.

7. The fuel cell according to claim 1, wherein the at least one structural element is sprayed onto the respective gas diffusion element.

8. A fuel cell stack having multiple fuel cells configured and arranged in accordance with claim 1.

9. An electrical aviation propulsion drive with a propeller or/and an aviation gas turbine, wherein the aviation propulsion drive is connected to at least one fuel cell stack according to claim 8.
